(19) United States
(12) Patent Application Publication
(10) Pub. No.: US 2026/0341274 A1
(43) Pub. Date: Oct. 29, 2026

(54) FORMATTING CONTENT WITH ARTIFICIAL INTELLIGENCE BASED ON TOPIC OF CONVERSATION

(71) Applicant: The Toronto-Dominion Bank, Toronto (CA)

(72) Inventors: Alexandre Dionne, Toronto (CA); Daniel Chan, Toronto (CA); Daniel Chammas, Toronto (CA); Danika Babin-Demers, Toronto (CA); Xuan Qin, Toronto (CA); Ian Wong, Toronto (CA); Alexandre Guertin, Toronto (CA); Debora Santelli, Toronto (CA); Xavier Dubé, Toronto (CA); Simranjit Warraich, Toronto (CA); Rajendra Dharaj, Toronto (CA); Myriam Benzaquen-Lasry, Toronto (CA); Mehran Moghtadai, Toronto (CA)

(73) Assignee: The Toronto-Dominion Bank, Toronto (CA)

(21) Appl. No.: 19/187,481

(22) Filed: Apr. 23, 2025

(51) Int. Cl. G10L 15/18; G06T 11/26

(52) U.S. Cl. CPC G10L 15/1815; G06T 11/26

(57) ABSTRACT

An example operation may include one or more of capturing speech data from a conversation as it occurs during a communication session conducted between a first device and a second device via the software application, identifying a topic of the conversation and data associated with the topic currently being discussed during the conversation based on the speech data, determining that the topic matches a list of topics that are stored within the software application, generating a display of the data based on execution of at least one AI model on the topic of the conversation and the data associated with the topic, and presenting the display of the data via a GUI of the software application while the topic of conversation is currently being discussed. The example operation may further include an AI agent performing an action related to the topic and the data associated with the topic.

### BACKGROUND

Communication software for managing inbound and outbound calls such as those that can occur between devices, at a contact center, at public safety access point (PSAP), and the like, provide technology that enables participants of a call to communicate over a network infrastructure. Meanwhile, artificial intelligence is a technology that enables computers (and machines) to simulate human behavior and even perform activities that may exceed what humans are capable of performing.

### SUMMARY

One example embodiment provides an apparatus that may include a memory, and at least one processor communicatively coupled to the memory, where the at least one processor may capture, by a software application, speech data from a conversation as it occurs during a communication session conducted between a first device and a second device via the software application, identify, by the software application, a topic of the conversation and data associated with the topic currently being discussed during the conversation based on the speech data, determine, by the software application, that the topic matches a list of topics that are stored within the software application, generate, by the software application, a display of the data based on execution of at least one AI model on the topic of the conversation and the data associated with the topic, and present, by the software application, the display of the data via a graphical user interface (GUI) of the software application while the topic of conversation is currently being discussed.

Another example embodiment provides a method that includes one or more of capturing, by a software application, speech data from a conversation as it occurs during a communication session conducted between a first device and a second device via the software application, identifying, by the software application, a topic of the conversation and data associated with the topic currently being discussed during the conversation based on the speech data, determining, by the software application, that the topic matches a list of topics that are stored within the software application, generating, by the software application, a display of the data based on execution of at least one artificial intelligence (AI) model on the topic of the conversation and the data associated with the topic, and presenting, by the software application, the display of the data via a graphical user interface (GUI) of the software application while the topic of conversation is currently being discussed.

A further example embodiment provides a computer-readable medium comprising instructions, that when read by a processor, cause the processor to perform one or more of capturing, by a software application, speech data from a conversation as it occurs during a communication session conducted between a first device and a second device via the software application, identifying, by the software application, a topic of the conversation and data associated with the topic currently being discussed during the conversation based on the speech data, determining, by the software application, that the topic matches a list of topics that are stored within the software application, generating, by the software application, a display of the data based on execution of at least one artificial intelligence (AI) model on the topic of the conversation and the data associated with the topic, and presenting, by the software application, the display of the data via a graphical user interface (GUI) of the software application while the topic of conversation is currently being discussed.

### BRIEF DESCRIPTION OF THE DRAWINGS

FIG. 1A is a diagram illustrating an operating environment of a software service, according to examples and features of the instant solution.

FIG. 1B is a diagram illustrating a computing environment for generating display content for a communication session using artificial intelligence according to examples and features of the instant solution.

FIG. 2A is a system diagram illustrating integration of an AI model into decision processes, according to the examples and features of the instant solution.

FIG. 2B is a diagram illustrating a process for developing an AI model that supports AI assisted computer decision points, according to the examples and features of the instant solution.

FIG. 2C is a diagram illustrating a process for utilizing an AI model that supports AI assisted computer decision points according to examples and features of the instant solution.

FIG. 3 is a system diagram illustrating an operating environment for a communication service according to the examples and features of the instant solution.

FIG. 4A is a diagram illustrating a process of training an AI model to learn formatting preferences of conversation content according to the examples and features of the instant solution.

FIG. 4B is a diagram illustrating a process of generating display content and outputting the display content during a communication session according to the examples and features of the instant solution.

FIG. 4C is a diagram illustrating a process of retraining the AI model according to the examples and features of the instant solution.

FIG. 5 is a diagram illustrating a process of altering a display of content during a communication session according to the examples and features of the instant solution.

FIGS. 6A-6C are diagrams illustrating a process of generating display content and altering the display content based on an ongoing communication session according to the examples and features of the instant solution.

FIG. 7A is a diagram illustrating a method of displaying spoken content in a different format according to the examples and features of the instant solution.

FIG. 7B is a diagram illustrating another method of displaying spoken content in a different format according to the examples and features of the instant solution.

FIG. 8 is a diagram illustrating a computing system that may be used in one, all, or many of the examples and features of the instant solution described herein.

### DETAILED DESCRIPTION

It is to be understood that although this disclosure includes a detailed description of cloud computing, implementation of the instant solution recited herein is not limited to a cloud computing environment. Rather, features of the instant solution are capable of being implemented in conjunction with any other type of computing environment now known or later developed.

The examples and features of the instant solution are directed to a system that can capture speech data from a conversation as it occurs during a communication session conducted between a first device and a second device via the software application. The system can identify a topic of the conversation being discussed during the conversation using artificial intelligence (AI), and detect that a topic currently being discussed can be enhanced through the use of display content. The system can then generate the display content using an AI model and output the display content while the topic is still being discussed during the conversation.

The display content may include text (e.g., phrases, words, sentences, etc.), visual content such as charts, graphs, pages, and the like. The display content may be output to a graphical user interface (GUI) of the software application which is shown on a display device of a device participating in the communication session. In some examples and features of the instant solution, the communication session may include multiple participants on multiple devices speaking with one another through the communication session. The display content may be shown on all of the devices participating in the communication session. The display content may be shown on one of the devices, rather than all of the devices.

For example, the system may capture speech data from a conversation as it occurs during a communication session conducted between a first device and a second device via the software application. The system may identify a topic of the conversation and data associated with the topic currently being discussed during the conversation based on the speech data, and determine that the topic matches a list of topics that are stored within the software application. The system may generate a display of the data based on execution of at least one artificial intelligence (AI) model on the topic of the conversation and the data associated with the topic, and present the display of the data via a graphical user interface (GUI) of the software application while the topic of conversation is currently being discussed.

For example, the at least one AI model may generate at least one of a chart and a graph which visually depicts the data associated with the topic, and present the at least one of the chart and the graph within a pop-up window on the GUI of the software application. The software may present the display content as an overlay on the GUI. Furthermore, in some examples and features of the instant solution, the system may receive additional speech data from the conversation as it occurs during the communication session and determine to modify the display of the data based on the additional speech data. Here, the system may alter what is being shown to include additional details, additional data, drill-down into finer details, and the like.

Related communication software can perform tasks such as enabling a communication session to occur between two devices participating in the communication session. However, the communication session typically includes speech data. In contrast, in the examples and features of the instant solution, the software can detect when a topic of conversation may be more effective visually rather than communicated verbally based on at least one AI model trained to understand the optimum format of various topics of conversation. The training of the at least one AI model may be performed based on historical communication sessions.

Some of the technical benefits of the examples and features of the instant solution include an AI-system generating display content using spoken content from the communication session. The AI-system can detect a topic of conversation and compare it to formatting details of the topic which can identify whether the topic is more effective when communicated with diagrams or other visual information rather than discussed. For example, content such as sales over time, asset performance over time, comparisons of different expenditures, and many others. By dynamically formatting content based on preferred methods of delivery, the system can provide a technical benefit that increases the communication capabilities of the software application by introducing visual content to help enhance the content that is being discussed (spoken) during the communication session.

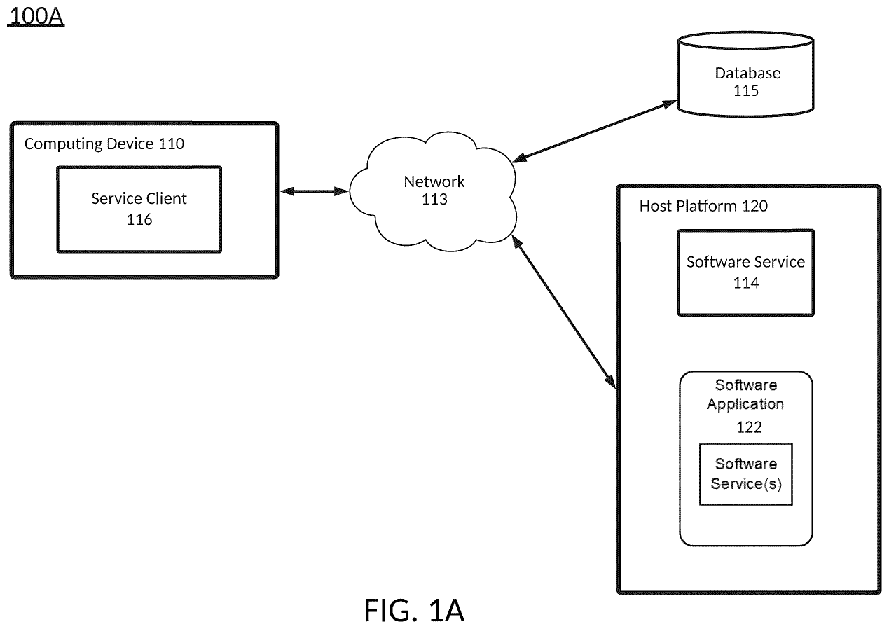

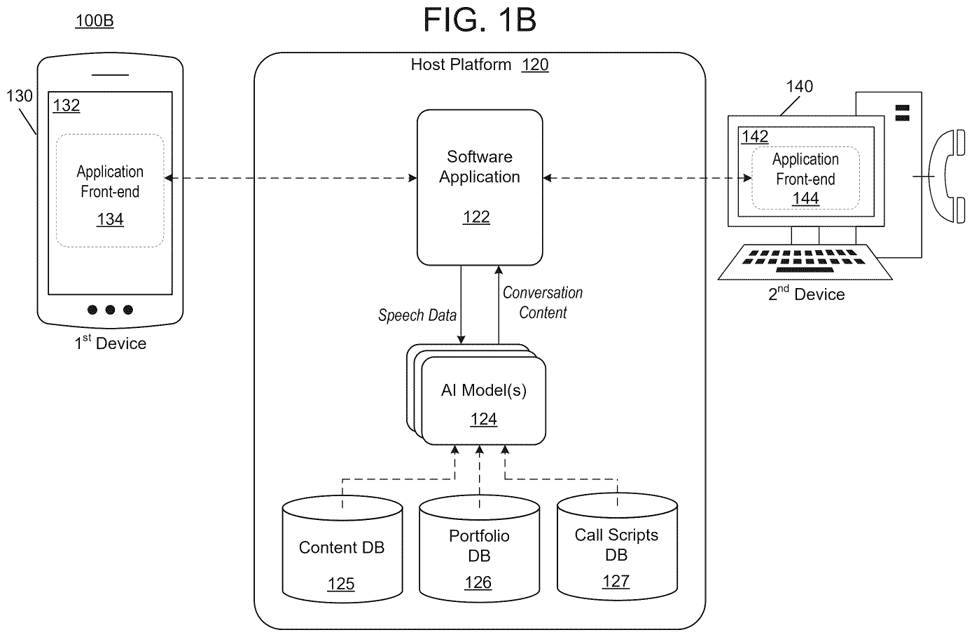

FIG. 1A illustrates an operating environment 100A of the instant solution. As shown, at least one computing device 110, and a host platform 120 communicate via a network 113. The host platform 120 may host a software service 114, a software application 122 containing at least one software service, and the like. The software service 114 and/or the software application 122 may communicate with at least one database 115 through a network 113 during the course of service execution. The computing device 110 may host a service client 116, which communicates with a corresponding software service 114.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 113 is a computer network and may include at least one interconnected computer network. For example, network 113 may be or may include an Ethernet network, an asynchronous transfer mode (ATM) network, a wireless network, a telecommunications network or the like.

The software service 114 provides the service logic. It may provide at least one Application Programming Interface (API) for communicating with at least one service client 116. A “thick” user interface client that runs on a computing device 110 may utilize the APIs to communicate with the software service 114. Further, the software service 114 may provide hosted User Interfaces (UIs) that can be accessed through browser-based software on some computing devices 110.

The software application 122 may include at least one service (e.g., at least one software service 114, etc.) For example, the software application 122 may include or otherwise be made up of a plurality of services that are independently managed with separate APIs.

The at least one service client 116 can enable service access for end users and may come in a variety of forms including, but not limited to, a mobile device application (“app”) or a web portal accessed via a browser on a computing device 110 such as a laptop or desktop computer.

FIG. 1B illustrates a computing environment 100B for generating display content for a communication session using artificial intelligence according to examples and features of the instant solution. Referring to FIG. 1B, the host platform 120, such as a cloud platform, web server, etc., may host a communication session, such as a meeting, between a first device 130 and a second device 140 through a software application 122. The host platform 120 may connect to the first device 130 and the second 140 over a computer network such as a cellular network, the Internet, a private network, and the like.

According to various examples and features of the instant solution, the first device 130 and the second device 140 may be at least one of a mobile device, a computer, a laptop, a desktop computer, a contact center access point, and the like. The first device 130 and the second device 140 may display conversation content from the conversation including text, images, and the like, and play audio (e.g., spoken by a user, spoken by a talking bot, etc.) from the conversation which can be output via speakers (not shown). For example, the first device 130 may also include a microphone (not shown) for capturing audio spoken by a user thereof which is then transferred to the second device 140 via the software application 122. Likewise, the second device 140 may include a microphone (not shown) for capturing audio spoken by a user thereof.

Here, the host platform 120 may host the software application 122 and make it accessible to the first device 130 and the second device 140 at the same time over a computer network such as the Internet. Thus, the first device 130 and the second device 140 may connect for a communication session via the software application 122. For example, the software application 122 may be a mobile application that includes a front-end which is installed on the first device 130 (and the second device 140) and a back-end which is installed on the host platform 120. The software application 122 may be a progressive web application (PWA) that is hosted by the host platform 120 and made accessible via a browser on the second device 140 and/or the first device 130 via an address on the web. The first device 130 and the second device 140 may display a graphical user interface (GUI) output by the software application 122, for example, an application front-end 134 GUI that is shown on a display device 132 of the first device 130, and an application front-end 144 GUI that is shown on a display device 142 of the second device 140.

In the examples and features of the instant solution, the host platform 120 may include one or more artificial intelligence (AI) models including at least one AI model 124 which is capable of ingesting speech data, visual data, audio, etc. from conversation content during a live conversation, and dynamically generate additional conversation content that can be displayed on one or more of the application front-end 134 and the application front-end 144, spoken during the communication session (e.g., by a talking bot) and the like. In some examples and features of the instant solution, the at least one AI model 124 may be trained on one or more of historical topics of conversation content within a data store such as content DB 125, user portfolio data stored in a data store such as portfolio DB 126, call transcripts stored in a data store such as call scripts DB 127, and the like. The host platform 120 may also include one or more additional models including one or more machine learning models, one or more AI models, and the like. The models including the at least one AI model 124 may be held by the host platform 120 within a model repository (not shown).

In the example of FIG. 1B, the first device 130 and the second device 140 may exchange speech, text, images, and the like, communications submitted through the software application 122. For example, audio may be spoken, text may be entered into a text box, documents may be viewed, and the like. The conversation between the users may be recorded by the software application 122, converted into a vector or other encoding, and submitted to the at least one AI model 124. In response, the at least one AI model 124 may dynamically detect topics that are being discussed during the meeting from the conversation content and dynamically generate GUI content to be displayed during the meeting or audio content to be spoken.

In some examples and features of the instant solution, the conversation content that is displayed during the communication session may include content that is visible to the first device 130 and the second device 140 and/or content that is visible to one of the devices. The software application 122 may control which device sees which content and create different experiences on the application front-ends of the first device 130 and the second device 140 during the communication session. Furthermore, the at least one AI model 124 may ingest speech data from the communication session and generate additional content that can be displayed and or spoken during the conversation and additional content that can be used after the communication session such as a call script, a call list, a link, and the like. The at least one AI model 124 may use audio with speech data from the conversation to detect when the conversation changes from one topic to another and modify the generated content or generate additional content in response to such a change.

In some examples and features of the instant solution, the host platform 120 acts as the central processing hub, hosting the software application 122 and at least one AI model 124 that implements a duplex model capable of input and output parallel processing. To capture speech data, the software application 122 monitors audio input from microphones on the first device 130 and the second device 140, converting the speech into text or structured data for processing. A topic of the conversation is identified by using the duplex model within the AI model 124 to use natural language processing to analyze the structured data, extract keywords and semantic meaning to determine the subject matter being discussed. The software application determines whether the topic matches stored topics by comparing the extracted topic against a list of predefined topics stored within the system's content DB 125. A real-time display of the data is generated by the duplex model. The duplex model processes the topic and its associated data, creating visual content such as charts or graphs tailored to the conversation context. The generated content is presented to the user via the sending of the visual data to the application front-end 134 GUI of the first device 130 and/or and the application front-end 144 GUI of the second device 140, rendering the content on display device 132 and/or display device 142. This data is updated based on new speech data received during the conversation.

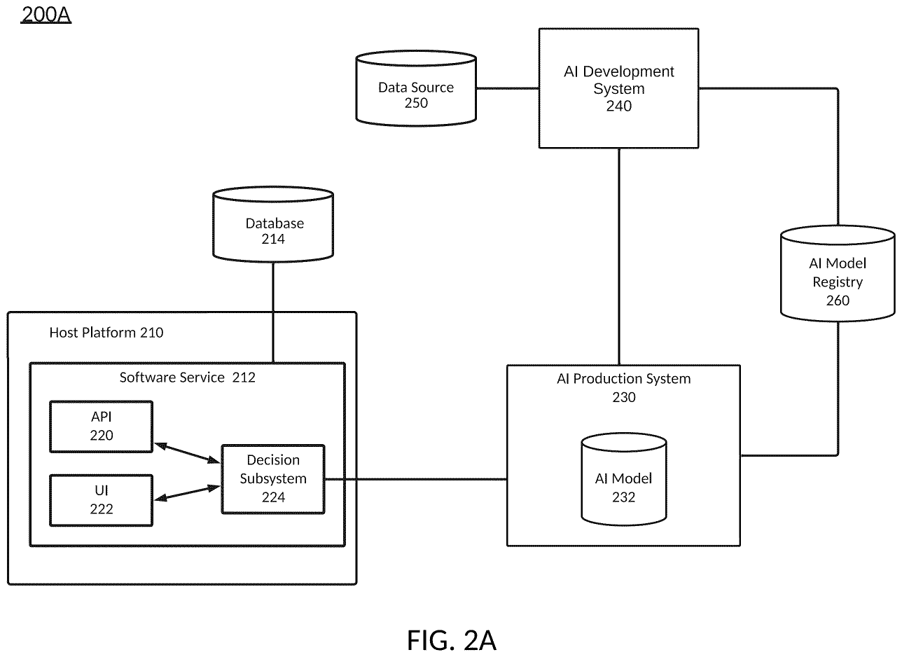

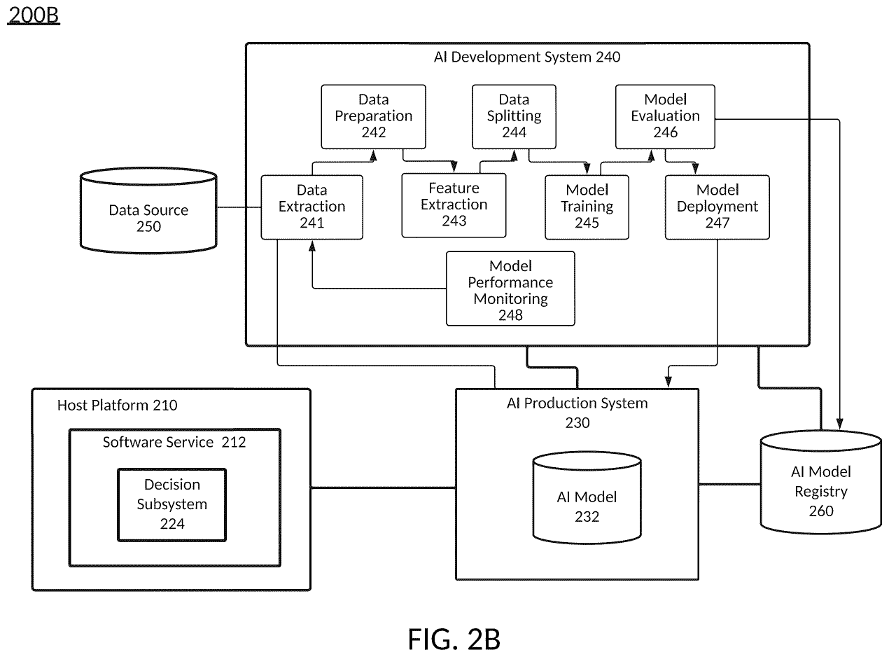

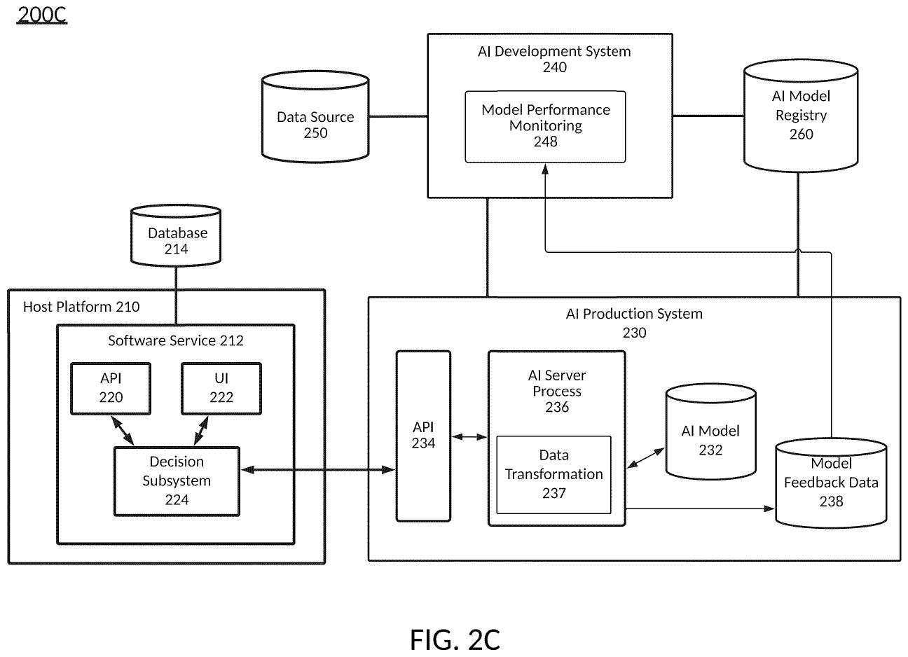

FIG. 2A illustrates an AI network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212 (see FIGS. 1A, 2A) , executing on host platform 210 (see FIGS. 1A and 2A) may provide at least one API 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of APIs 220 send data to at least one decision subsystem 224 of the software service 212 to assist in decision-making. In some examples and features of the instant solution, the software service 212 stores data included in API requests or data generated during processing the API requests into at least one database 214 (see FIGS. 1A, 2A).

Software service 212 may provide at least one user interface (UI) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an API 220 or a UI 222.

An AI production system 230 may be used by a decision subsystem 224 in a software service 212 to assist in its decision-making process. The AI production system 230 includes at least one AI model 232 that is executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 212, UI 222 data from software service 212 or data from other software service 212 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

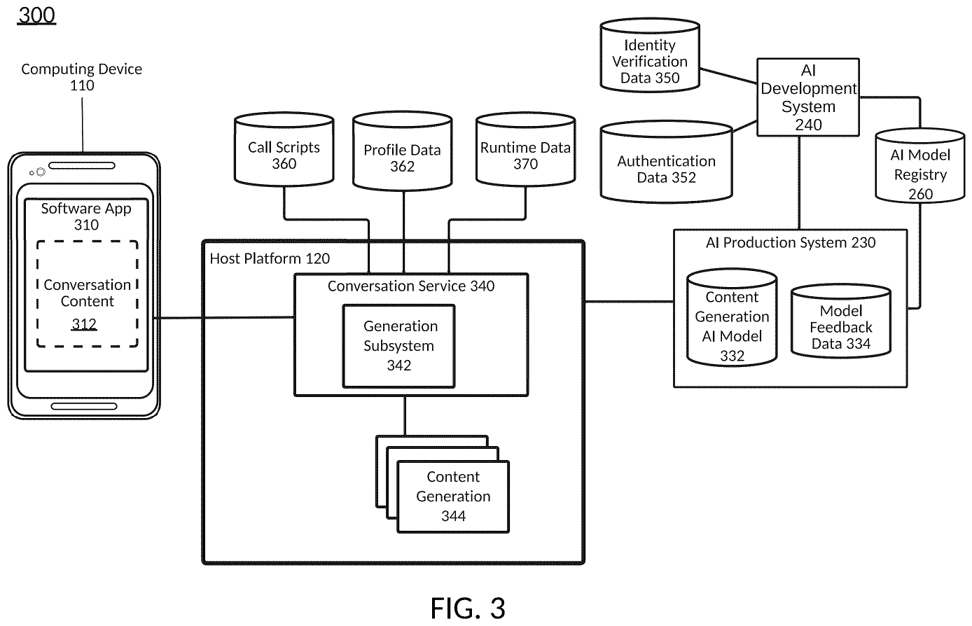

FIG. 3 illustrates an operating environment 300 for a communication service according to the examples and features of the instant solution. In some examples and features of the instant solution, a content generation AI model 332 is trained using at least one of historical call scripts, historical profile data, runtime data including feedback, and the like, to generate conversation content that can be injected into a communication session given a set of feature data transformed from a set of application data and computing device data. The content generation AI model 332 is an example of AI Model 232 (see, for example, FIGS. 2A-2C) . The historical call scripts, historical profile data, runtime data including feedback are examples of data source 250 (see, for example, FIGS. 2A-2C). The training of the content generation AI model 332 may be evaluated based on identity verification data 350, authentication data 352, and the like.

In some examples and features of the instant solution, the content generation AI model 332 is trained using at least one neural network training method such as, but not limited to, gradient descent, stochastic gradient descent, random search, uniform search, basin hopping, and Krylov. In some examples and features of the instant solution, the content generation AI model 332 is a single or multi-layer perceptron neural network, a feed-forward neural network, a radial basis functional neural network, a recurrent neural network, or a modular neural network.

In some examples and features of the instant solution, the content generation AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data for the content generation AI model 332 may include, but is not limited to, internal data sources, external data sources, private data sources, public data sources, historical call scripts, historical profile data, runtime data including feedback, or the like.

In some examples and features of the instant solution, historical call scripts may include, but is not limited to, call scripts previously recorded between the same devices, different devices, and the like. The historical call scripts may include the utterances that are spoken, identifiers of which user spoke which utterances, timestamps of the utterances, and the like. The utterance may include a textual description of the audio from a historical video call, phone call, web call, meeting, or the like. The historical profile data may include profile data of the users that participated in the historical calls including which calls the users participated. The runtime data may include feedback that is automatically captured by the software and/or that is received from a GUI, etc.

The model feedback records in the model feedback data 334 may include, but is not limited to, inputs entered via a GUI which indicate whether the conversation content was spoken by one of the users, was good or bad, etc. The model feedback data 334 may include data that is automatically detected by the software application. For example, the software application may verify whether or not suggested content is spoken by one of the parties by capturing the audio from the communication session, converting it into text, and verifying that the conversation content is included therein.

Once the content generation AI model 332 is trained and validated, it is deployed to an AI production system 230 (see, for example, FIGS. 2A-2C, 3) for use by a conversation service 340. The conversation service 340 is an example of software service 114 or software service 212 (see, for example, FIGS. 1A, 2A-2C).

In some examples and features of the instant solution, software app 310, running on computing device 110, is an example of service client 116 (see FIG. 1A). The software app 310 may be a teleconferencing software application, a conferencing software application, a meeting software application, a contact center software application, a mobile application, or the like. The software app 310 may enable users to speak with one another over a network such as a cellular telephone network, the Internet, and the like. The software app 310 may also display content on a GUI of the software app 310, such as conversation content 312. The software app 310 may also display content generated by the content generation AI model 332.

In some examples and features of the instant solution, the conversation service 340 receives data from the software app 310. The data may include, but is not limited to, call scripts, images, text, audio, and the like.

Additionally, the conversation service 340 receives data about the computing device 110. The device data may include, but is not limited to, the media access control (MAC) address and the source internet protocol (IP) address of the computing device.

For example, the conversation service 340 may host a conversation between a first device and a second device. During the conversation, the conversation service 340 may instantiate a generation subsystem 342 which listens to the conversation (e.g., words, phrases, utterances, etc.) that are spoken during the conversation and determines whether or not to generate conversation content. When the generation subsystem 342 determines to generate conversation content, the generation subsystem 342 executes a process for content generation 344 which may invoke the content generation AI model 332 in the AI production system 230 for generative content that can be displayed, spoken, or the like, within the conversation. The invocation to the AI production system 230 may include speech data spoken within the conversation, call scripts, and the like. The content for the call may include data from a database of call scripts 360, a database of profile data 362, a database of runtime data 370, and the like, in addition to the speech data.

In response to receiving the invocation, the content generation AI model 332 may generate conversation content that may include at least one of an utterance, a phrase, a script, and the like, which can be output during the conversation. The conversation content may be provided to the conversation service 340 and output to a GUI of the software app 310, spoken by a talking bot via the software app 310, and the like.

According to various examples and features of the instant solution, the system described herein may detect a topic of conversation that is currently being discussed during a communication session such as a live teleconference, telephone call, meeting, video call, etc., and automatically generate additional content (e.g., display content) that is rendered on a display of a device participating in the communication session. The display content may enhance the discussion by showing additional data, metadata, etc., associated with the topic which can further increase the understanding of the topic by the participants participating in the conversation. This is new in the art of telecommunication software.

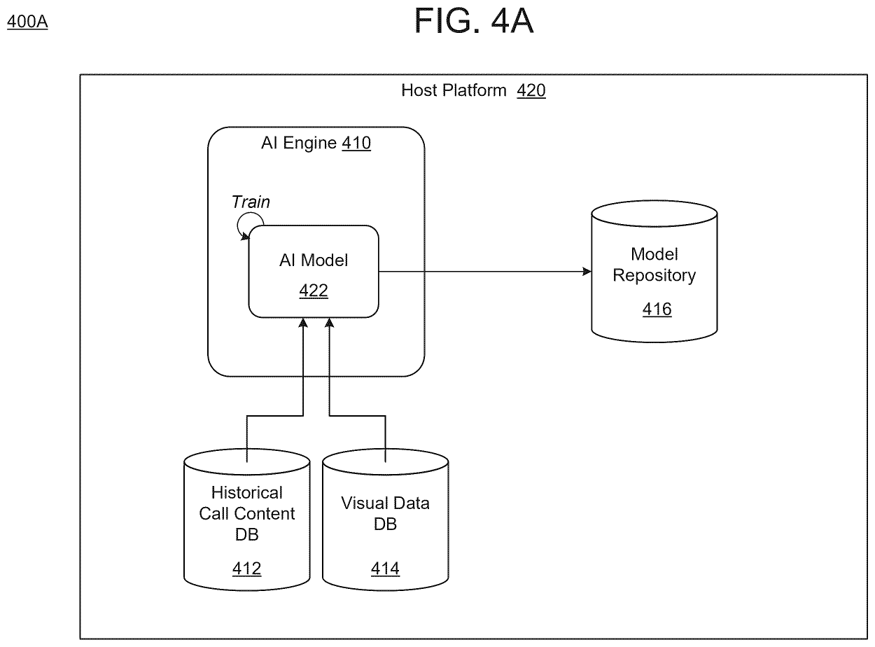

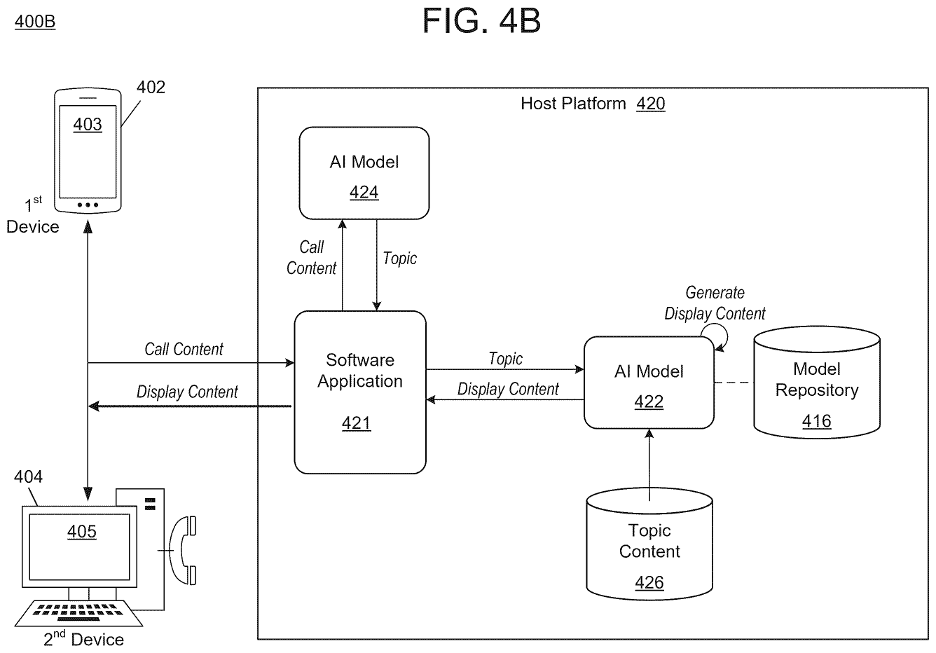

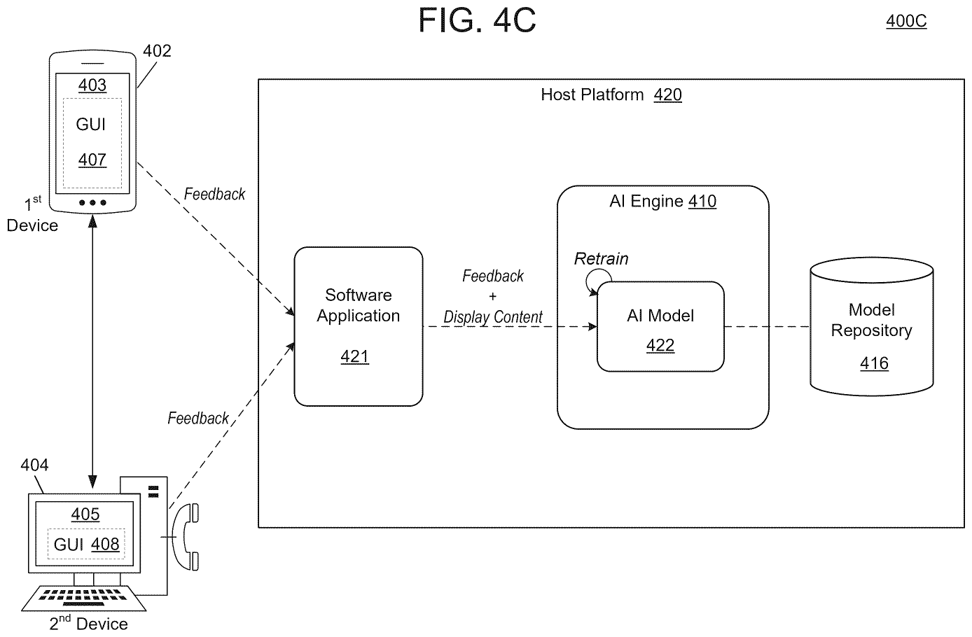

FIG. 4A illustrates a process 400A of training an AI model 422 to learn formatting preferences of conversation content according to the examples and features of the instant solution. Referring to FIG. 4A, a host platform 420 may host an AI engine 410 that is capable of training the AI model 422 by executing the AI model 422 while inputting training data into the AI model 422, causing the AI model 422 to generate predicted outputs. The host platform 420 may be a cloud platform, a web server, a distributed system, or the like. The host platform 420 may also host a software application 421 (shown in FIG. 4B) which allows devices to connect to one another and conduct communication sessions such as telephone calls, video calls, teleconferences, meetings, and the like. For example, the devices may connect to the host platform 420 over a computer network such as a data network, a cellular network, and the like.

The AI engine 410 may train the AI model 422 through multiple iterations (epochs) in an iterative manner until the training data is completed or a predetermined number of training epochs are completed. The training data may include unlabeled data from which the AI model 422 can learn patterns and preferences. For example, the training data may include at least one of historical conversation content, historical call scripts, historical profile data, and the like, from a database such as a historical call content DB 412. The training data may include at least one of images, pictures, charts, graphs, pages of content, etc. from a database such as a visual data DB 414. The visual data content may be associated with the historical conversation content enabling the AI model 422 to learn visual data that is associated with the historical conversation content.

In some examples and features of the instant solution, the AI model 422 may be a multi-modal model such as a multi-modal large language (LLM) capable of understanding connections between images and text. The AI model 422 may use a shared vector space for both image content and text content enabling the AI model 422 to understand connections between images and text. The AI model 422 may be trained and then stored within a model repository 416 of the host platform 420.

FIG. 4B illustrates process 400B of generating display content and outputting the display content during a communication session according to the examples and features of the instant solution. Referring to FIG. 4B, a first device 402 and a second device 404 may connect to the host platform 420 via the software application 421. Through the software application 421, the first device 402 and the second device 404 may conduct a communication session such as a video call, a teleconference, a telephone call, etc. During the communication session, participants may speak into microphones on the first device 402 and the second device 404 which is transmitted to the other device and captured by the software application 421.

The conversation content captured by the software application 421 may be input to an AI model 424 that is configured to determine a topic of the conversation. The topic may include a subject matter of the conversation (e.g., sports, investments, particular types of investments, news, entertainment, insurance claims, etc.). The topic may be returned to the software application 421 and input to an AI model 422 by the software application 421. Here, the AI model 422 may be retrieved from the model repository 416 and used to determine whether or not the topic can be enhanced with display content (another format of content). The software application 421 may also input speech data from the conversation into the AI model 422 along with the topic. In addition, content about various topics stored within a database such as topic content 426 may be ingested by the AI model 422 and used for generating content associated with the topic.

In response, the AI model 422 can identify visual content that can be included in the conversation based on the topic and generate a display of the visual content. The display content may be provided from the AI model 422 to the software application 421. The software application 421 may render the visual content on a display device 403 of the first device 402 and/or a display device 405 of the second device 404 during the communication session and while the topic is still being discussed.

FIG. 4C illustrates a process 400C of retraining the AI model according to the examples and features of the instant solution. Referring to FIG. 4C, the software application 421 may request feedback from the first device 402 and/or the second device 404. For example, the software application 421 may display a GUI 407 on the first device 402 and a GUI 408 on the second device 404 which users can input feedback regarding the generated display content. The feedback may include indications of whether the use of the display content was helpful/beneficial or whether the display content was not helpful. The feedback may be input through the display device 403 of the first device 402 and/or the display device 405 of the second device 404 and provided to the software application 421.

The software application 421 may take the feedback from the display content, the topic, and the call content and provide it as an input to the AI engine 410. The AI engine 410 may retrain the AI model 422 based on the feedback. This enables the AI engine 410 to become more accurate over time because the AI model 422 can learn based on direct feedback from the participants in the communication session thereby increasing the effectiveness of future communication sessions and display content generated and displayed therein.

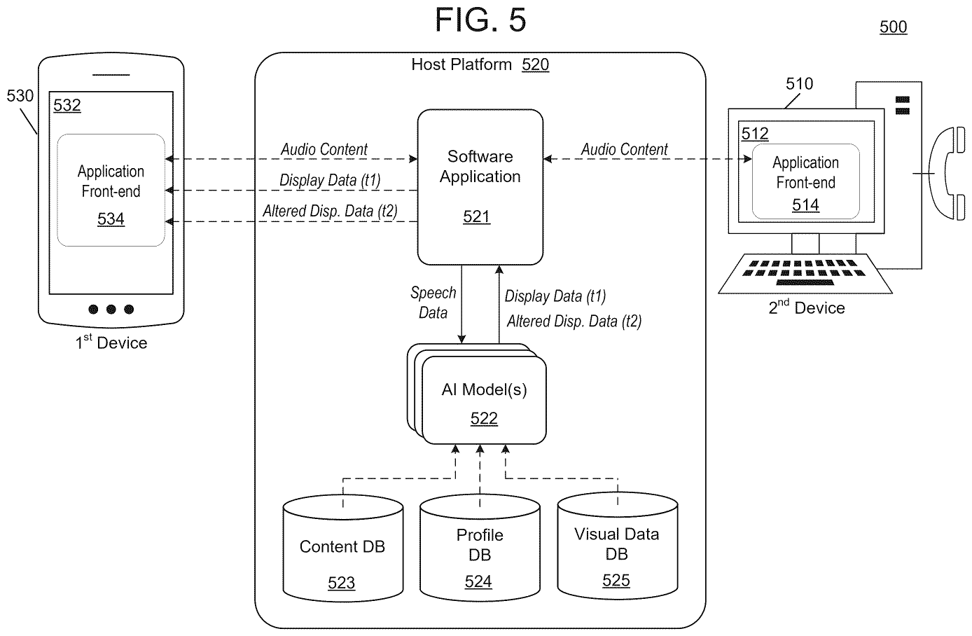

FIG. 5 illustrates a process 500 of altering a display of content during a communication session according to the examples and features of the instant solution. Referring to FIG. 5, a host platform 520 may host a software application 521 that enables participants to conduct communication sessions between themselves (on different devices). The software application 521 may correspond to the software application 421 that is shown and described with respect to the examples of FIGS. 4A-4C. In this example, the software application 521 includes or is otherwise communicatively coupled to at least one AI model(s) 522 that is trained to generate visual content for content being spoken during a communication session.

The software application 521 may include a front-end that is installed and running on participating devices. In the example of FIG. 5, a first device 530 and a second device 510 are communicating with one another via the software application 521. Here, the first device 530 includes a display device 532 where a GUI of the software application 521 can be rendered. Here, the GUI may be part of an application front-end 534 that is running on the first device 530 and that is coupled to the back-end (e.g., of the software application 521). Likewise, the second device 510 includes a display device 512 where a GUI of the software application 521 can be rendered. Here, the GUI may be part of an application front-end 514 that is running on the second device 510 and that is coupled to the back-end.

The software application 521 may capture speech data from the communication session, for example, from audio devices on the first device 530 and the second device 510. For example, the application front-end 534 may capture/record audio from a microphone on the first device 530. Likewise, the application front-end 514 may record/capture audio from a microphone on the second device 510. The captured audio may be provided to the software application 521. This process may be iteratively performed throughout the communication session. For example, at predetermined intervals (e.g., 5 seconds, 10 seconds, etc.) audio from the conversation may be converted to text and provided to the software application 521. The utterances captured by one of the front-end applications can be sent to the software application 521 regardless of the time.

The speech data may be provided to the at least one AI model(s) 522 which determines when display content is to be generated and generates the display content. For example, the speech data may be provided to a first AI model which determines a topic of the conversation, and the topic and the speech data may be provided to a second AI model among the at least one AI model(s) 522 which determines to generate the visual content and which generates the visual content.

The visual content (display data) may be output by the at least one AI model(s) 522 and provided to the software application 521. Furthermore, the software application 521 may output the display data to at least one of the first device 530 and the second device 510 during the communication session. In this example, the software application 521 outputs the display data to the application front-end 534 on the first device 530 but not the application front-end 514 on the second device 510. However, this is just for purposes of example. It should be appreciated that the display content may be output to all participating devices or some of the participating devices, depending on the topic, the settings, etc.

To generate the display content, the at least one AI model(s) 522 may ingest additional data about the topic such as call content from a database such as content DB 523, profile content of one or more of the participants of the communication session from a database such as profile DB 524, visual content from a database such as visual data DB 525, and the like.

According to various examples and features of the instant solution, the software application 521 may dynamically alter the content that is generated by the at least one AI model(s) 522 and that is being displayed during the communication session. For example, the software application 521 may capture additional speech data from the communication session, identify at least one of a keyword and a phrase uttered within the additional speech data, and alter the display of the data via the GUI of the software application based on the at least one of the keyword and the phrase.

Here, the software application 521 may send the additional speech data, the topic, the display content, etc. to the at least one AI model(s) 522 which then modifies the display content or otherwise generates new content that can be displayed. The altered display data may be output to the application front-end 534 for visualization. The output process may include supplementing the originally displayed data by combining it with the alternate display content. Likewise, the originally displayed data may be replaced with the alternate display content.

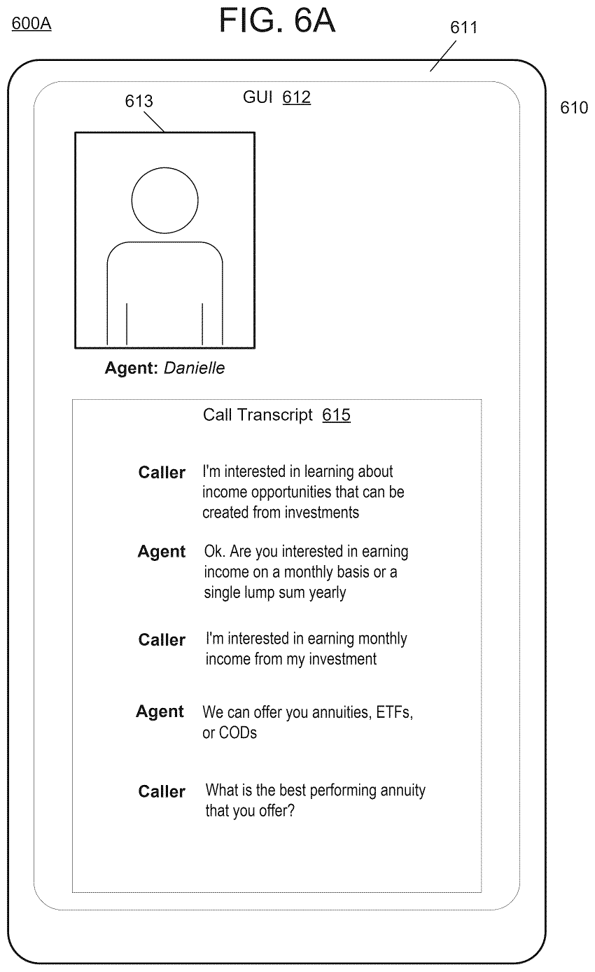

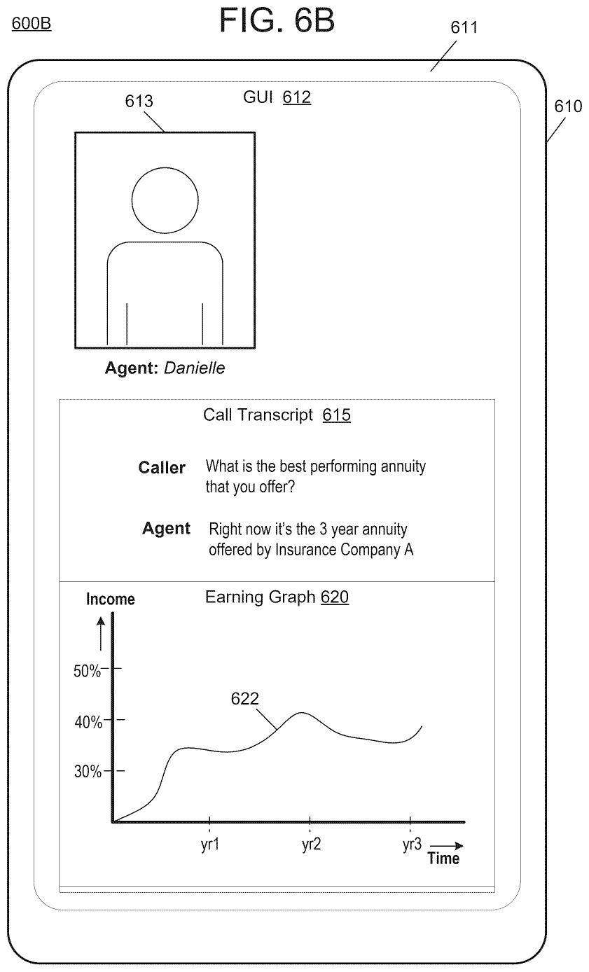

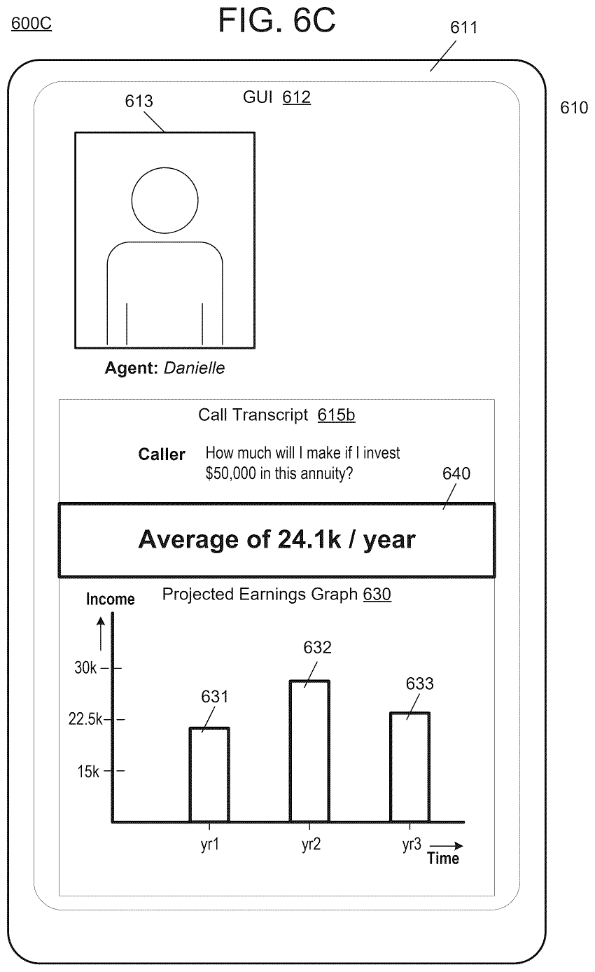

FIGS. 6A-6C illustrate a process of generating display content and altering the display content based on an ongoing communication session according to the examples and features of the instant solution. For example, FIG. 6A illustrates a process 600A of displaying a call transcript from a communication session in real-time (as the communication session is occurring). Here, the transcript may be displayed on a device 610 which may correspond to one of the first device 530 and the second device 510 shown in the example of FIG. 5.

Referring to FIG. 6A, the software application may render a GUI 612 on a display device 611 of the device 610. The GUI 612 may be part of an application front-end. The GUI 612 may include a call transcript 615 that includes a speech-to-text conversation of the utterances that have been spoken up to this point in the communication session. The GUI 612 also includes a picture 613 of a participant of the conversation, for example, the participant that is speaking on the other device (not device 610). The picture may include attributes of the person such as their name, location, contact information, company, and/or the like. As more content is spoken during the communication session, the software application may update the call transcript 615 by adding additional utterances which have been converted to text.

FIG. 6B illustrates a process 600B of rendering display content generated by at least one AI model on the GUI 612 of the device 610 during the communication session. Referring to FIG. 6B, the software application described herein may continuously listen to the speech data that is being spoken during the communication session and feed the speech to at least one AI model such as the at least one AI model(s) 522 in FIG. 5. The at least one AI model may determine to generate display content to supplement the conversation that is being discussed during the ongoing communication session.

In the example of FIG. 6B, the conversation being discussed is about income of an asset (e.g., an annuity) offered by a company. In this case, a second participant may be asking the first participant about the income of the annuity over the last few years, or the like. The at least one AI model may detect that the topic of conversation is about the income of an asset and determine that display content can enhance the conversation. In response, the at least one AI model may determine to generate visual data to enhance the description of the income of the asset. The at least one AI model may retrieve asset content such as historical performance data of the asset from a database, which contains the income data of the asset over a period of time. The at least one AI model may generate an earning graph 620 with a wave signal 622 which represents the income of the asset over time for the last few years.

Here, the software application may determine to output the earning graph 620 to the devices participating in the communication session including the device 610. For example, the graph 620 may be output as a pop-up window within the call transcript 615 (e.g., a window which includes the call transcript 615, etc.). The earning graph 620 may be output as an overlay that is overlaid over the call transcript 615 and/or other data being displayed on the GUI 612 of the device 610.

FIG. 6C illustrates a process 600C of alerting the display content on the GUI 612 based on additional speech data from the communication session. According to various examples and features of the instant solution, the software application described herein may dynamically alter content that is generated by the at least one AI model and that is being rendered/output during a communication session. As an example, the alteration may include increasing a size of the content being displayed, changing a color of the content being displayed, moving the location of the content being displayed, increasing the number of pixels used to display the content, changing the content being displayed, and the like. The at least one AI model may also determine what format to display content, for example, whether it is to be displayed as text, a chart, a graph, a combination of formats, and the like.

In the example of FIG. 6C, the participant asks about how their portfolio would have looked the last three years with 50 k invested in the high-performing annuity included in it. The additional utterance causes the call transcript 615 to be modified to include the most-recent utterance thereby generating a modified call transcript 615b. The at least one AI model may determine that the question can be answered by the at least one AI model and shown visually with alternate content on the display screen. In this case, the at least one AI model generates a new/different graph (e.g., estimated earnings graph 630), which shows what the participant would have earned over the last three years if they had invested in the annuity. In this example, the projected earnings graph 630 is a bar graph with bars 631, 632, and 633 representing forecasted income of the asset for three different periods of time. The at least one AI model also determines to display textual data 640 to more effectively communicate the content.

In this example, the at least one AI model determines to delete the previous display content (the earning graph 620) and replace it with the projected earnings graph 630 and the textual data 640 in its place/same location on the GUI 612. This process may be iteratively repeated throughout the communication session.

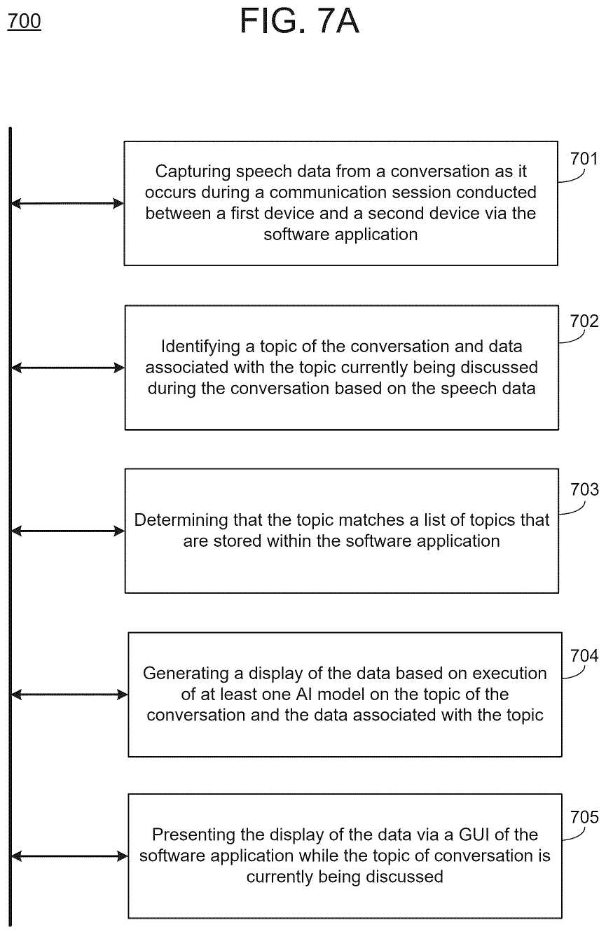

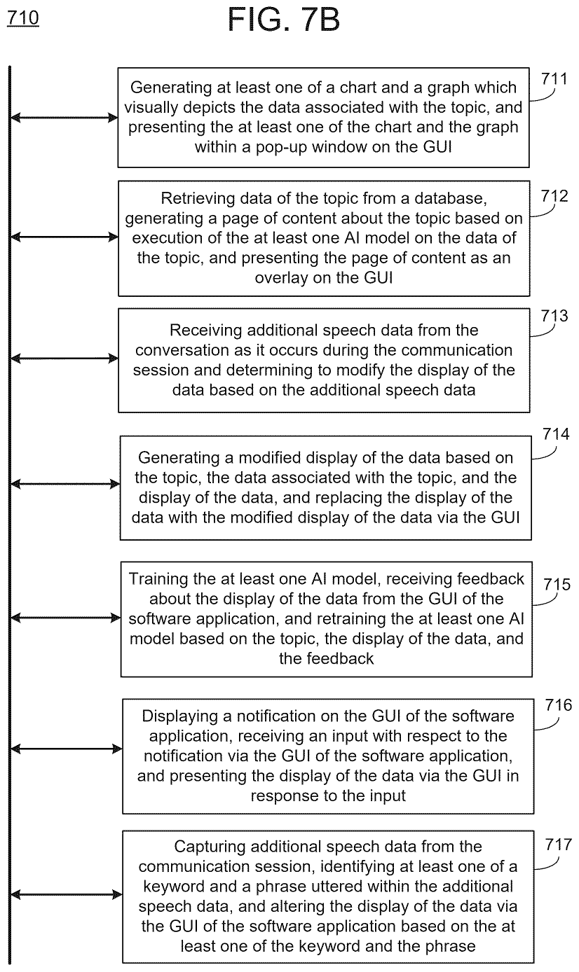

FIG. 7A illustrates a method 700 of displaying spoken content in a different format according to the examples and features of the instant solution. As an example, the method 700 may be performed by a computing system, a software application, a server, a cloud platform, a combination of systems, and the like. Referring to FIG. 7A, in 701, the method may include capturing, by a software application, speech data from a conversation as it occurs during a communication session conducted between a first device and a second device via the software application. In 702, the method may include identifying, by the software application, a topic of the conversation and data associated with the topic currently being discussed during the conversation based on the speech data.

In 703, the method may include determining, by the software application, that the topic matches a list of topics that are stored within the software application. In 704, the method may include generating, by the software application, a display of the data based on execution of at least one artificial intelligence (AI) model on the topic of the conversation and the data associated with the topic. In 705, the method may include presenting, by the software application, the display of the data via a graphical user interface (GUI) of the software application while the topic of conversation is currently being discussed.

FIG. 7B illustrates a method 710 of displaying spoken content in a different format according to the examples and features of the instant solution. As an example, the method 710 may be performed by a computing system, a software application, a server, a cloud platform, a combination of systems, and the like. Referring to FIG. 7B, in 711, the method may include generating at least one of a chart and a graph which visually depicts the data associated with the topic, and presenting the at least one of the chart and the graph within a pop-up window on the GUI of the software application. In 712, the method may further include retrieving data of the topic from a database, generating content about the topic based on execution of the at least one AI model on the data of the topic, and presenting the content as an overlay on the GUI.

In 713, the method may include receiving additional speech data from the conversation as it occurs during the communication session and determining to modify the display of the data based on the additional speech data. In 714, the method may include generating a modified display of the data based on execution of the at least one AI model on at least one of the topic, the data associated with the topic, the display of the data, and replacing the display of the data with the modified display of the data via the GUI. In 715, the method may include training the at least one AI model based on at least one of historical conversation content, historical call scripts, and historical profile data, receiving feedback about the display of the data from the GUI of the software application, and retraining the at least one AI model based on the topic, the display of the data, and the feedback.

In 716, the method may further include displaying a notification on the GUI of the software application and receiving an input with respect to the notification via the GUI of the software application, and presenting the display of the data via the GUI in response to the input. In 717, the method may include capturing additional speech data from the communication session, identifying at least one of a keyword and a phrase uttered within the additional speech data, and altering the display of the data via the GUI of the software application based on the at least one of the keyword and the phrase.

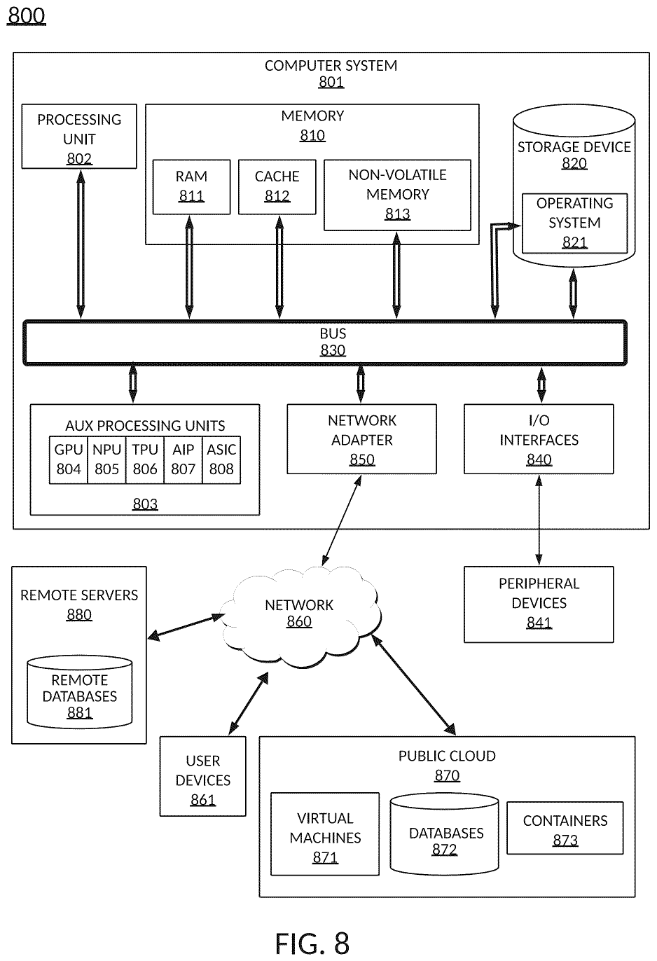

The examples and features of the instant solution may be implemented in at least one of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM) , flash memory, read-only memory (ROM), erasable programmable read-only memory (EPROM), electrically erasable programmable read-only memory (EEPROM) , registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, specifically computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. As shown in FIG. 8, computer system 801 in computing environment 800 is shown in the form of a general-purpose computing device. The components of computer system 801 may include but are not limited to, at least one processor or processing unit 802, a system memory 810, and a bus 830 that couples various system components, including system memory 810 to processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

The Auxiliary Processing Units (APU) 803 may contain at least one Graphics Processing Unit (GPU) 804, Neural Processing Unit (NPU) 805, Tensor Processing Unit (TPU) 806, AI Processor (AIP) 807, or other Application Specific Integrated Circuit (ASIC) 808. The at least one APU 803 may contain circuitry distributed over multiple integrated circuit chips. The APU 803 may implement multiple processor threads and multiple processor cores. The APU 803 may include at least one of onboard memory, onboard memory cache, and onboard instruction cache. The APU may be communicatively coupled to the system bus 830 and configure to communicate with other system components, including a processing unit 802, system cache 812, RAM 811, non-volatile RAM 813, operating system 821, Network adapter 850, and Input/Output interfaces 840. In some computing environments, at least one of the at least one APU 803 may be designed to work with qubits and perform quantum computing.

Memory 810 is any volatile memory now known or to be developed in the future. Examples include dynamic random-access memory (RAM) 811 or static type RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. A typical computer system 801 may include cache 812, a specialized volatile memory generally faster than RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by peripheral storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via an input/output (I/O) interface, 840. Such devices may include a keyboard, a pointing device, a display, etc. ; at least one device that enables a user to interact with computer system 801; and/or any devices (e.g., network card, modem, etc.) that enable computer system 801 to communicate with at least one other computing devices. Such communication can occur via I/O interface 840. As depicted, I/O interface 840 communicates with the other components of computer system 801 via bus 830.

Network adapter 850 enables the computer system 801 to connect and communicate with at least one network 860, such as a local area network (LAN), a wide area network (WAN), and/or a public network (e.g., the Internet). It bridges the computer's internal bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LANs designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. U ser devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running a software application on the host operating system 821. Containers 873 are built on top of the host operating system's kernel and contain software applications and some lightweight operating system A PIs and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA) , a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms aligned with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution of at least one of a method, apparatus, computer-readable storage medium system, and other element, structure, component, or device as represented in the attached figures are not intended to limit the scope of the instant solution as claimed but are merely representative of aspects and examples of the instant solution. Any of the components described or depicted herein that perform a same or similar functionality may be a same or similar component. For example, different AI-related components that are described or depicted may be the same AI component.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor communicatively coupled to the memory, wherein the at least one processor is configured to:
capture, by a software application, speech data from a conversation as it occurs during a communication session conducted between a first device and a second device via the software application;
identify, by the software application, a topic of the conversation and data associated with the topic currently being discussed during the conversation based on the speech data;
determine, by the software application, that the topic matches a list of topics that are stored within the software application;
generate, by the software application, a display of the data based on execution of at least one artificial intelligence (AI) model on the topic of the conversation and the data associated with the topic; and
present, by the software application, the display of the data via a graphical user interface (GUI) of the software application while the topic of conversation is currently being discussed.

2. The apparatus of claim 1, wherein the at least one processor is configured to generate at least one of a chart and a graph which visually depicts the data associated with the topic, and present the at least one of the chart and the graph within a pop-up window on the GUI of the software application, wherein an AI agent performs an action related to the topic and the data associated with the topic.

3. The apparatus of claim 1, wherein the at least one processor is configured to retrieve data of the topic from a database, generate content about the topic based on execution of the at least one AI model on the data of the topic, and present the content as an overlay on the GUI.

4. The apparatus of claim 1, wherein the at least one processor is further configured to receive additional speech data from the conversation as it occurs during the communication session and determine to modify the display of the data based on the additional speech data.

5. The apparatus of claim 4, wherein the at least one processor is further configured to generate a modified display of the data based on execution of the at least one AI model on at least one of the topic, the data associated with the topic, the display of the data, and replace the display of the data with the modified display of the data via the GUI.

6. The apparatus of claim 1, wherein the at least one processor is further configured to train the at least one AI model based on at least one of historical conversation content, historical call scripts, and historical profile data, receive feedback about the display of the data from the GUI of the software application, and retrain the at least one AI model based on the topic, the display of the data, and the feedback.

7. The apparatus of claim 1, wherein the at least one processor is further configured to display a notification on the GUI of the software application, receive an input with respect to the notification via the GUI of the software application, and present the display of the data via the GUI in response to the input.

8. The apparatus of claim 1, wherein the at least one processor is further configured to capture additional speech data from the communication session, identify at least one of a keyword and a phrase uttered within the additional speech data, and alter the display of the data via the GUI of the software application based on the at least one of the keyword and the phrase.

9. A method comprising:
capturing, by a software application, speech data from a conversation as it occurs during a communication session conducted between a first device and a second device via the software application;
identifying, by the software application, a topic of the conversation and data associated with the topic currently being discussed during the conversation based on the speech data;
determining, by the software application, that the topic matches a list of topics that are stored within the software application;
generating, by the software application, a display of the data based on execution of at least one artificial intelligence (AI) model on the topic of the conversation and the data associated with the topic; and
presenting, by the software application, the display of the data via a graphical user interface (GUI) of the software application while the topic of conversation is currently being discussed.

10. The method of claim 9, wherein the generating the display of data comprises generating at least one of a chart and a graph which visually depicts the data associated with the topic, and presenting the at least one of the chart and the graph within a pop-up window on the GUI of the software application, wherein an AI agent performs an action related to the topic and the data associated with the topic.

11. The method of claim 9, wherein the generating the display of data comprises retrieving data of the topic from a database, generating content about the topic based on execution of the at least one AI model on the data of the topic, and presenting the content as an overlay on the GUI.

12. The method of claim 9, further comprising receiving additional speech data from the conversation as it occurs during the communication session and determining to modify the display of the data based on the additional speech data.

13. The method of claim 12, further comprising generating a modified display of the data based on execution of the at least one AI model on at least one of the topic, the data associated with the topic, the display of the data, and replacing the display of the data with the modified display of the data via the GUI.

14. The method of claim 9, further comprising training the at least one AI model based on at least one of historical conversation content, historical call scripts, and historical profile data, receiving feedback about the display of the data from the GUI of the software application, and retraining the at least one AI model based on the topic, the display of the data, and the feedback.

15. The method of claim 9, further comprising displaying a notification on the GUI of the software application and receiving an input with respect to the notification via the GUI of the software application, wherein the presenting comprises presenting the display of the data via the GUI in response to the input.

16. The method of claim 9, further comprising capturing additional speech data from the communication session, identifying at least one of a keyword and a phrase uttered within the additional speech data, and altering the display of the data via the GUI of the software application based on the at least one of the keyword and the phrase.

17. A computer-readable storage medium comprising instructions which when executed by a processor cause the processor to perform:
capturing, by a software application, speech data from a conversation as it occurs during a communication session conducted between a first device and a second device via the software application;
identifying, by the software application, a topic of the conversation and data associated with the topic currently being discussed during the conversation based on the speech data;
determining, by the software application, that the topic matches a list of topics that are stored within the software application;
generating, by the software application, a display of the data based on execution of at least one artificial intelligence (AI) model on the topic of the conversation and the data associated with the topic; and
presenting, by the software application, the display of the data via a graphical user interface (GUI) of the software application while the topic of conversation is currently being discussed.

18. The computer-readable storage medium of claim 17, wherein the generating the display of data comprises generating at least one of a chart and a graph which visually depicts the data associated with the topic, and presenting the at least one of the chart and the graph within a pop-up window on the GUI of the software application, wherein an AI agent performs an action related to the topic and the data associated with the topic.

19. The computer-readable storage medium of claim 17, wherein the generating the display of data comprises retrieving data of the topic from a database, generating content about the topic based on execution of the at least one AI model on the data of the topic, and presenting the content as an overlay on the GUI.

20. The computer-readable storage medium of claim 17, wherein the instructions further cause the processor to perform receiving additional speech data from the conversation as it occurs during the communication session and determining to modify the display of the data based on the additional speech data.
